(19) United States
(12) Patent Application Publication
(10) Pub. No.: US 2013/0166479 A1
(43) Pub. Date: Jun. 27, 2013

(54) METHOD AND APPARATUS FOR CALCULATING ENERGY REVENUES OF ELECTRIC POWER DEVICES BASED ON REAL TIME PRICING

(71) Applicants: Tae In HWANG, Daejeon (KR); Il WOO LEE, Daejeon (KR)

(72) Inventors: Tae In HWANG, Daejeon (KR); Il WOO LEE, Daejeon (KR)

(73) Assignee: Electronics and Telecommunications Research Institute, Daejeon (KR)

(21) Appl. No.: 13/612,219

(22) Filed: Sep. 12, 2012

(30) Foreign Application Priority Data
Dec. 27, 2011 (KR) 10-2011-0143493

(51) Int. Cl. G06Q 50/06

(52) U.S. Cl. 705/412

(57) ABSTRACT

A method and apparatus for calculating energy revenues of electric power devices based on real time pricing is provided. The energy revenue calculating apparatus may synchronize time between the energy revenue calculating apparatus and at least one of a real time energy pricing information providing server and a time information providing server, based on time information received from at least one of the real time energy pricing information providing server and the time information providing server, synchronize an energy sale price stored in the energy revenue calculating apparatus with an energy sale price, based on energy sale price information received from the real time energy pricing information providing server, and calculate energy revenues for a predetermined time period, based on the received energy sale price information and information about an amount of energy that flows into and out of the plurality of electric power devices.

### CROSS-REFERENCE TO RELATED APPLICATION

This application claims the benefit of Korean Patent Application No. 10-2011-0143493, filed on Dec. 27, 2011, in the Korean Intellectual Property Office, the disclosure of which is incorporated herein by reference.

### BACKGROUND

1. Field of the Invention

The present invention relates to a method and apparatus for calculating energy revenues of electric power devices based on real time pricing that may calculate real time energy revenues of the electric power devices by reflecting energy pricing information that changes in real time, under a smart grid based real time pricing environment.

2. Description of the Related Art

A conventional energy system has a unidirectional structure through which a user, as a simple consumer, may be supplied with electric power passively. However, with the introduction of various renewable energy sources and the development of technologies directed to energy storage devices, an energy system is being changed to a bidirectional energy system whereby an individual user as well as a utility provider may produce and provide energy. Accordingly, electric power may be supplied from a renewable energy source, an energy storage device, or the like to an electrical grid, whereby a fixed and simple energy pricing system provided by several utility providers is being changed to a real time pricing system. In addition, efforts to apply such a real time pricing system are being made in order to induce efficient electricity consumption through active user participation.

In order to promote efficiency of electricity usage, much more information may need to be supplied to an electricity consumer. When a user is able to verify information about real time electric charges for each electric power device, sales revenues, and the like, the user may use electrical appliances in a more efficient manner. However, since a conventional kilowatt-hour meter and electric rates charging systems focus on calculation of electric rates for each household, the conventional systems may measure an amount of electric power for each device, however, may fail to provide real time energy revenues by calculating the real time energy revenues of each electric power device based on real time pricing.

Accordingly, there is a demand for a method of calculating real time energy revenues of electric power devices by reflecting energy pricing that changes in real time, and outputting corresponding information to a mobile terminal of a user, an electric power device, and the like.

### SUMMARY

An aspect of the present invention provides a method and apparatus for calculating energy revenues of electric power devices based on real time pricing that may calculate and output real time energy revenues of electric power devices by reflecting energy pricing that changes in real time, under a real time energy pricing system.

According to an aspect of the present invention, there is provided an apparatus for calculating energy revenues, the apparatus including a time synchronizing unit to synchronize time between the apparatus for calculating energy revenues and at least one of a real time energy pricing information providing server and an authorized time information providing server, based on time information received from the at least one of the real time energy pricing information providing server and the authorized time information providing server, a real time energy pricing information synchronizing unit to synchronize an energy sale price stored in the apparatus for calculating energy revenues with an energy sale price that changes in real time, based on energy sale price information received from the real time energy pricing information providing server, an energy inflow and outflow measuring unit to measure an amount of energy that flows into and out of the electric power devices, and a real time energy revenue calculating unit to calculate energy revenues for a predetermined time period, based on the received energy sale price information and information about the amount of energy measured.

The apparatus for calculating energy revenues may further include a real time energy revenue output unit to output information about the calculated energy revenues.

The real time energy revenue output unit may transmit the information about the calculated energy revenues to a predetermined information display device.

The apparatus for calculating energy revenues may be provided in each of the electric power devices.

According to another aspect of the present invention, there is also provided an apparatus for calculating energy revenues, the apparatus including a time synchronizing unit to synchronize time between the apparatus for calculating energy revenues and at least one of a real time energy pricing information providing server and an authorized time information providing server, based on time information received from at least one of the real time energy pricing information providing server and the authorized time information providing server, a real time energy pricing information synchronizing unit to synchronize an energy sale price stored in the apparatus for calculating energy revenues with an energy sale price that changes in real time, based on energy sale price information received from the real time energy pricing information providing server, and a real time energy revenue calculating unit to calculate energy revenues for a predetermined time period, based on the received energy sale price information and information about an amount of energy that flows into and out of the plurality of electric power devices.

According to still another aspect of the present invention, there is also provided a method of calculating energy revenues, the method including receiving time information from at least one of a real time energy pricing information providing server and an authorized time information providing server, synchronizing time between an apparatus for calculating energy revenues and at least one of a real time energy pricing information providing server and an authorized time information providing server, based on the received time information, synchronizing information about an energy sale price previously stored in the apparatus for calculating energy revenues with an energy sale price that changes in real time, based on energy sale price information received from the real time energy pricing information providing server, measuring an amount of energy that flows into and out of electric power devices, and calculating energy revenues for a predetermined time period, based on the received energy sale price information and information about the amount of energy measured.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for calculating energy revenues of electric power devices based on real time pricing according to an embodiment of the present invention;

FIG. 2 is a flowchart illustrating a method of calculating energy revenues of electric power devices based on real time pricing according to an embodiment of the present invention;

FIG. 3 is a diagram illustrating a system for calculating energy revenues of electric power devices based on real time pricing according to an embodiment of the present invention;

FIG. 4 is a timing diagram illustrating a method of calculating energy revenues of electric power devices based on real time pricing according to an embodiment of the present invention;

FIG. 5 is a diagram illustrating a system for calculating energy revenues of electric power devices based on real time pricing according to another embodiment of the present invention; and

FIG. 6 is a timing diagram illustrating a method of calculating energy revenues of electric power devices based on real time pricing according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

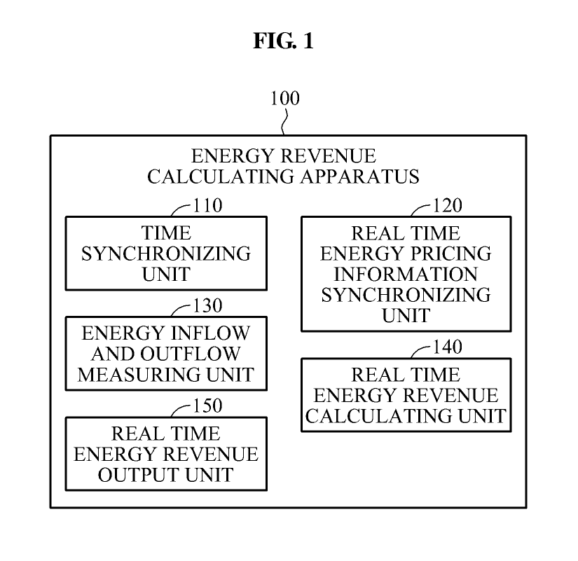

FIG. 1 is a block diagram illustrating an apparatus 100 for calculating energy revenues of electric power devices based on real time pricing according to an embodiment of the present invention.

Referring to FIG. 1, the energy revenue calculating apparatus 100 may include a time synchronizing unit 110, a real time energy pricing information synchronizing unit 120, an energy inflow and outflow measuring unit 130, a real time energy revenue calculating unit 140, and a real time energy revenue output unit 150 in order to calculate the energy revenues of the electric power devices, under a smart grid based real time pricing environment.

The time synchronizing unit 110 may receive accurate authorized time information from a real time energy pricing information providing server, an authorized time information providing server, or the like, and may synchronize time between the energy revenue calculating apparatus 100 and the real time energy pricing information providing server, based on the received time information.

The real time energy pricing information synchronizing unit 120 may receive real time energy sale price information, price change schedule information, and the like from the real time energy pricing information providing server, and may synchronize information about an energy sale price previously stored in the energy revenue calculating apparatus 100 with information about an energy sale price that changes in real time, based on the received real time energy sale price information, the received price change schedule information, and the like.

The energy inflow and outflow measuring unit 130 may measure an amount of energy that flows into and out of electric power devices, for example, a renewable energy source, an electric power storage device, an electric device including an electric power storage device, and the like.

The real time energy revenue calculating unit 140 may calculate energy revenues according to an amount of energy that flows into and out of the electric power devices for a predetermined time period, based on the received energy sale price information and information about the amount of energy measured by the energy inflow and outflow measuring unit 130.

The real time energy revenue output unit 150 may output information about the energy revenues calculated by the real time energy revenue calculating unit 140 so that a user may verify the information about the energy revenues through the electric power devices in real time.

Here, the real time energy revenue output unit 150 may transmit the information about the calculated energy revenues to a predetermined information display device, for example, a mobile terminal, a personal computer (PC), a tablet PC, and the like, thereby enabling the user to verify the energy revenues more conveniently in real time.

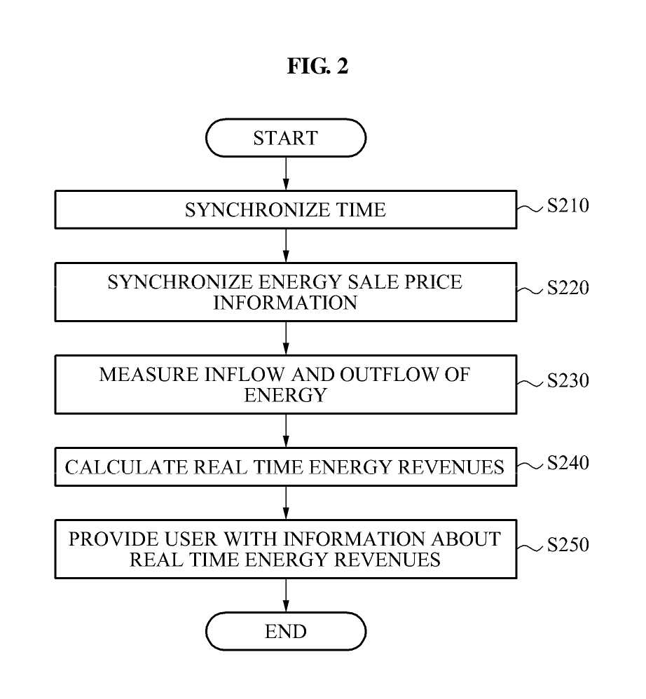

FIG. 2 is a flowchart illustrating a method of calculating energy revenues of electric power devices based on real time pricing according to an embodiment of the present invention.

In order to calculate energy revenues of electric power devices under a smart grid based real time pricing environment, an energy revenue calculating apparatus may receive accurate authorized time information from a real time energy pricing information providing server or an authorized time information providing server, and may synchronize time information of the energy revenue calculating apparatus with the received time information, in operation S210. The energy revenue calculating apparatus may receive real time energy sale price information, price change schedule information, and the like from the real time energy pricing information providing server, and may continuously synchronize information about an energy sale price stored in the energy revenue calculating apparatus with the received energy sale price information, in operation S220.

The energy revenue calculating apparatus may measure an amount of energy that flows into and out of electric power devices, for example, a renewable energy source, an electric power storage device, an electric device including an electric power storage device, and the like which interwork with the energy revenue calculating apparatus, in operation S230. The energy revenue calculating apparatus may calculate real time energy revenues based on an amount of energy that flows into and out of the electric power devices at a current point in time or for a predetermined time period, and the received real time energy sale price information, in operation S240.

The energy revenue calculating apparatus may provide output information so that a user may verify information about the energy revenues of the electric power devices, using a corresponding electric power device or a mobile terminal of the user, in operation S250.

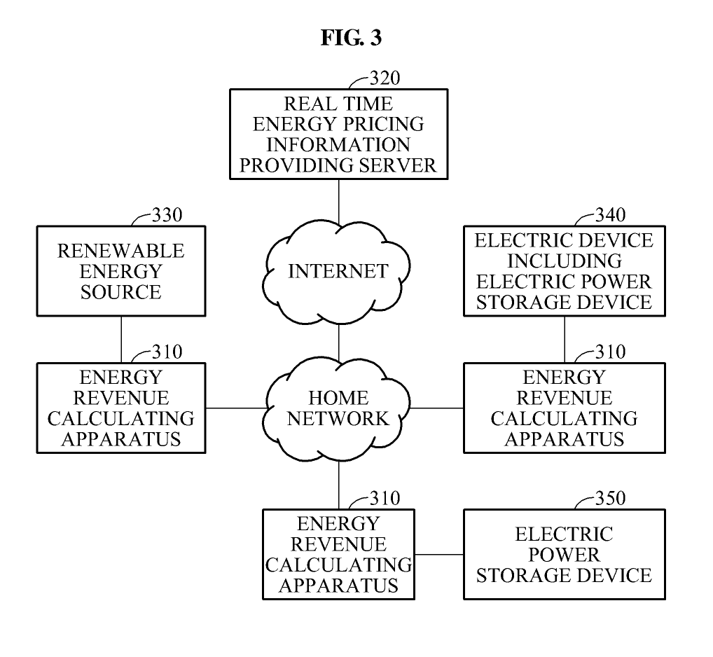

FIG. 3 is a diagram illustrating a system for calculating energy revenues of electric power devices based on real time pricing according to an embodiment of the present invention.

Referring to FIG. 3, energy revenue calculating apparatuses 310 may be provided in a renewable energy source 330, an electric device 340 including an electric power storage device, an electric power storage device 350, and the like, respectively. In this instance, in order to calculate the energy revenues of the electric power devices under a smart grid based real time pricing environment, each energy revenue calculating apparatus 310 may receive, over the Internet, accurate authorized time information from a real time energy pricing information providing server 320 or an authorized time information providing server (not shown), and may synchronize time information of each energy revenue calculating apparatus 310 with the received time information. In addition, each energy revenue calculating apparatus 310 may receive real time energy sale price information from the real time energy pricing information providing server 320, and may continuously synchronize information about an energy sale price stored in each energy revenue calculating apparatus 310 with the received energy sale price information. Each energy revenue calculating apparatus 310 may measure an amount of energy that flows into and out of the renewable energy source 330, the electric device 340 including an electric power storage device, the electric power storage device 350, and the like, each including the energy revenue calculating apparatus 310. Each energy revenue calculating apparatus 310 may calculate the energy revenues in real time, based on information about the amount of energy measured, and the energy sale price information received from the real time energy pricing information providing server 320, and may display the calculated energy revenues. Here, when the energy revenue calculating apparatuses 310 are installed in a house, the energy revenue calculating apparatuses 310 may be connected to one another, over a home network.

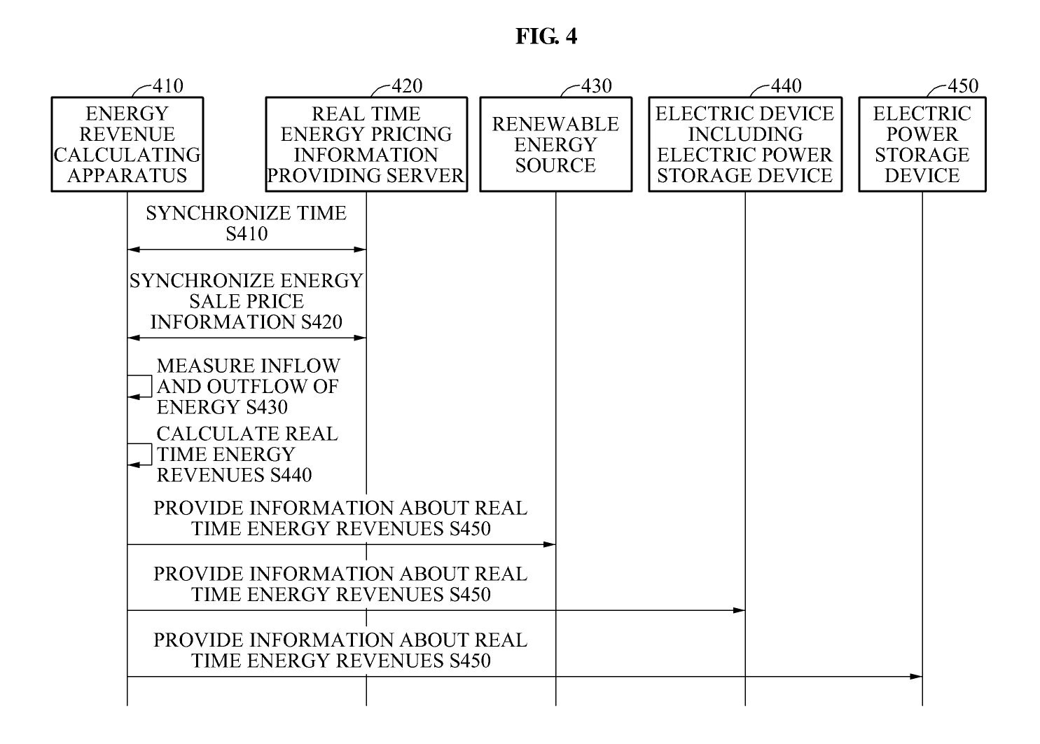

FIG. 4 is a timing diagram illustrating a method of calculating energy revenues of electric power devices based on real time pricing according to an embodiment of the present invention.

When an energy revenue calculating apparatus 410 is provided in a renewable energy source 430, an electric device 440 including an electric power storage device, and an electric power storage device 450, an operation of the energy revenue calculating apparatus 410 in the entire system for calculating the energy revenues of the electric power devices under a smart grid based real time pricing environment according to the present exemplary embodiment will be described herein.

The energy revenue calculating apparatus 410 may receive accurate authorized time information from a real time energy pricing information providing server 420 or an authorized time information providing server (not shown), and may synchronize time information of the energy revenue calculating apparatus 410 with the received time information, in operation S410. The energy revenue calculating apparatus 410 may receive real time energy sale price information, and information about a price change schedule, and the like, from the real time energy pricing information providing server 420, and may continuously synchronize information about an energy sale price stored in the energy revenue calculating apparatus 410 with the received energy sale price information, in operation S420.

The energy revenue calculating apparatus 410 may measure an amount of energy that flows into and out of the renewable energy source 430, the electric device 440 including an electric power storage device, and the electric power storage device 450, in operation S430. The energy revenue calculating apparatus 410 may calculate the real time energy revenues, based on information about the amount of energy measured at a current point in time, or for a predetermined time period, and the received real time energy sale price information, in operation S440.

The energy revenue calculating apparatus 410 may provide information about the real time energy revenues so that a user may verify the information about the energy revenues through a corresponding electric power device, for example, the renewable energy source 430, the electric device 440 including an electric power storage device, or the electric power storage device 450, a mobile terminal of a user, or the like, in operation S450.

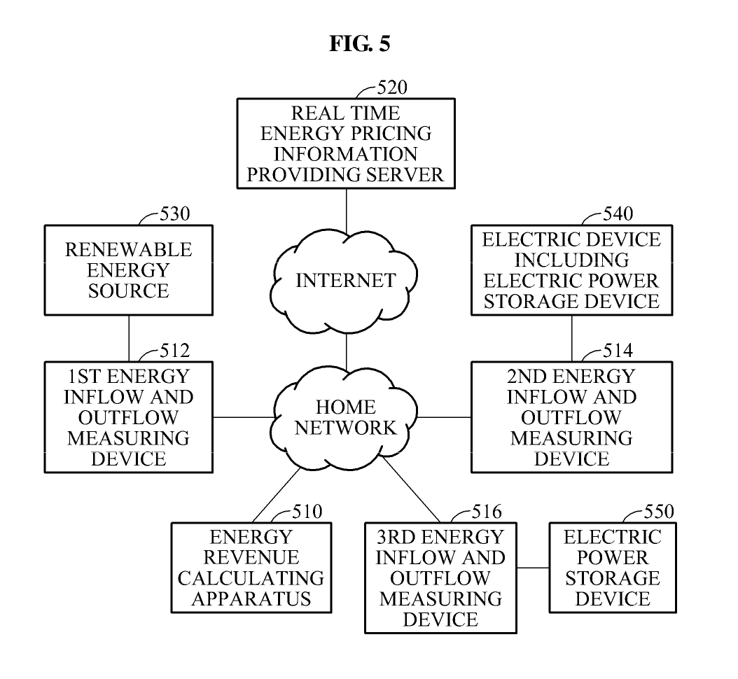

FIG. 5 is a diagram illustrating a system for calculating energy revenues of electric power devices based on real time pricing according to another embodiment of the present invention.

Referring to FIG. 5, an energy revenue calculating apparatus 510 may integrally manage real time energy revenues of electric power devices, without belonging to the electric power devices, for example, a renewable energy source 530, an electric device 540 including an electric power storage device, and an electric power storage device 550. In this instance, under a smart grid based real time pricing environment, the energy revenue calculating apparatus 510 may synchronize time with a real time energy pricing information providing server 520 that may provide energy sale price information in real time. In addition, the energy revenue calculating apparatus 510 may synchronize energy pricing information between the energy revenue calculating apparatus 510 and the real time energy pricing information providing server 520, based on energy pricing information received from the real time energy pricing information providing server 520. The energy revenue calculating apparatus 510 may calculate the real time energy revenues of the electric power devices, by collecting information about an amount of energy that flows into and out of each of the electric power devices from a first energy inflow and outflow measuring device 512, a second energy inflow and outflow measuring device 514, and a third energy inflow and outflow measuring device 516. Here, the first energy inflow and outflow measuring device 512, the second energy inflow and outflow measuring device 514, and the third energy inflow and outflow measuring device 516 may be provided in the renewable energy source 530, the electric device 540 including an electric power storage device, and the electric power storage device 550, respectively. In this instance, the energy revenue calculating apparatus 510 may be connected to each of the first energy inflow and outflow measuring device 512, the second energy inflow and outflow measuring device 514, and the third energy inflow and outflow measuring device 516, over a home network.

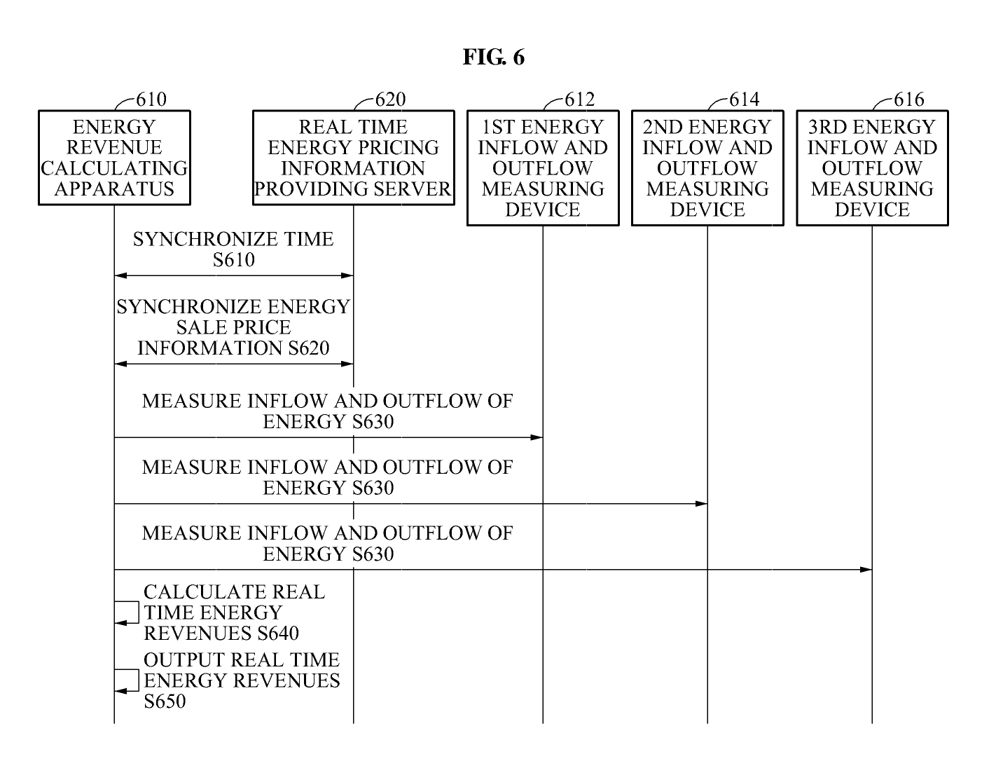

FIG. 6 is a timing diagram illustrating a method of calculating energy revenues of electric power devices based on real time pricing according to another embodiment of the present invention.

When an energy revenue calculating apparatus 610 integrally manages energy revenues of electric power devices, without belonging to the electric power devices, for example, a renewable energy source, an electric device including an electric power storage device, and an electric power storage device, an operation of the energy revenue calculating apparatus 610 under a smart grid based real time pricing environment according to the present exemplary embodiment will be described herein.

The energy revenue calculating apparatus 610 may receive accurate authorized time information from a real time energy pricing information providing server 620 or an authorized time information providing server (not shown), and may synchronize time information of the energy revenue calculating apparatus 610 with the received time information, in operation S610. The energy revenue calculating apparatus 610 may receive real time energy sale price information, and information about a price change schedule, and the like, from the real time energy pricing information providing server 620, and may continuously synchronize energy pricing information of the energy revenue calculating apparatus 610 with the received energy sale price information, in operation S620.

The energy revenue calculating apparatus 610 may collect information about an amount of energy that flows into and out of each of the renewable energy source, the electric device including an electric power storage device, the electric power storage device, and the like from a first energy inflow and outflow measuring device 612, a second energy inflow and outflow measuring device 614, and a third energy inflow and outflow measuring device 616, in operation S630. The energy revenue calculating apparatus 610 may calculate the energy revenues of the electric power devices, based on the received real time energy sale price information, and the collected information about the amount of the energy that flows into and out of each of the electric power devices, in operation S640. The energy revenue calculating apparatus 610 may directly output information about the energy revenues, or provide output information to a mobile terminal of a user so that the user may verify the information about the energy revenues of the electric power devices, in operation S650.

According to embodiments of the present invention, under a smart grid based real time pricing environment, a method and apparatus for calculating energy revenues of electric power devices based on real time pricing may calculate the energy revenues by synchronizing time and energy sale price between the apparatus for calculating energy revenues and a real time energy pricing information providing server, and measuring an amount of energy that flows into and out of the electric power devices such that a user may verify detailed information about real time electric charges, sale revenues, and the like for each electric power device in real time, whereby it is possible to control electricity consumption of electric devices in a more efficient manner, and to promote efficient electricity consumption at each house.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for calculating energy revenues, the apparatus comprising:
a time synchronizing unit to synchronize time between the apparatus for calculating energy revenues and at least one of a real time energy pricing information providing server and an authorized time information providing server, based on time information received from the at least one of the real time energy pricing information providing server and the authorized time information providing server;
a real time energy pricing information synchronizing unit to synchronize an energy sale price stored in the apparatus for calculating energy revenues with an energy sale price that changes in real time, based on energy sale price information received from the real time energy pricing information providing server;
an energy inflow and outflow measuring unit to measure an amount of energy that flows into and out of the electric power devices; and
a real time energy revenue calculating unit to calculate energy revenues for a predetermined time period, based on the received energy sale price information and information about the amount of energy measured.

2. The apparatus of claim 1, further comprising:
a real time energy revenue output unit to output information about the calculated energy revenues.

3. The apparatus of claim 2, wherein the real time energy revenue output unit transmits the information about the calculated energy revenues to a predetermined information display device.

4. The apparatus of claim 1, wherein the apparatus for calculating energy revenues is provided in each of the electric power devices.

5. An apparatus for calculating energy revenues, the apparatus comprising:
a time synchronizing unit to synchronize time between the apparatus for calculating energy revenues and at least one of a real time energy pricing information providing server and an authorized time information providing server, based on time information received from at least one of the real time energy pricing information providing server and the authorized time information providing server;
a real time energy pricing information synchronizing unit to synchronize an energy sale price stored in the apparatus for calculating energy revenues with an energy sale price that changes in real time, based on energy sale price information received from the real time energy pricing information providing server; and
a real time energy revenue calculating unit to calculate energy revenues for a predetermined time period, based on the received energy sale price information and information about an amount of energy that flows into and out of the plurality of electric power devices.

6. The apparatus of claim 5, wherein the real time energy revenues calculating unit calculates the energy revenues, based on the received energy sale price information, and the information about the amount of energy received from an energy inflow and outflow measuring device,
wherein the energy inflow and outflow measuring device is provided in each of the plurality of electric power devices, and interworks with the apparatus for calculating energy revenues to measure the amount of energy that flows into and out of the plurality of electric power devices.

7. The apparatus of claim 5, further comprising:
a real time energy revenue output unit to output information about the calculated energy revenues.

8. The apparatus of claim 5, wherein the real time energy revenue output unit transmits the information about the calculated energy revenues to a predetermined information display device.

9. A method of calculating energy revenues, the method comprising:
receiving time information from at least one of a real time energy pricing information providing server and an authorized time information providing server;
synchronizing time between an apparatus for calculating energy revenues and at least one of a real time energy pricing information providing server and an authorized time information providing server, based on the received time information;
synchronizing information about an energy sale price previously stored in the apparatus for calculating energy revenues with an energy sale price that changes in real time, based on energy sale price information received from the real time energy pricing information providing server;
measuring an amount of energy that flows into and out of electric power devices; and
calculating energy revenues for a predetermined time period, based on the received energy sale price information and information about the amount of energy measured.

10. The method of claim 9, further comprising:
outputting information about the calculated energy revenues.

11. The method of claim 9, further comprising:
transmitting the information about the calculated energy revenues to a predetermined information display device.
